(19) United States
(12) Patent Application Publication
(10) Pub. No.: US 2004/0147422 A1
(43) Pub. Date: Jul. 29, 2004

(54) Cleaner composition for formed metal articles

(76) Inventors: Andrew M. Hatch, Lake Orion, MI (US); Gary L. Rochfort, Shelby Township, MI (US); Richard D. Banaszak, Sterling Heights, MI (US)

Correspondence Address: BROOKS KUSHMAN P.C./ HENKEL CORPORATION, 1000 TOWN CENTER, TWENTY-SECOND FLOOR, SOUTHFIELD, MI, 48075-1238, US

(21) Appl. No.: 10/350,965

(22) Filed: Jan. 23, 2003

(51) Int. Cl. C11D 1/00

(52) U.S. Cl. 510/202; 510/421

(57) ABSTRACT

The present invention discloses an improved cleaning composition for cleaning metal surfaces such as aluminum and aluminum-containing alloys. The cleaning composition of the present invention comprises water and an ethoxylate of an alcohol having Formula R₁—OH wherein R₁ is a saturated or unsaturated, straight-chain or branched aliphatic having from 12 to 22 carbon atoms; an inorganic pH adjusting component; and at least one surfactant that is different than the ethoxylate set forth above.

### BACKGROUND OF THE INVENTION

1. Field of the Invention

In one aspect, the present invention is related to aqueous acidic compositions for cleaning metal surfaces, and in particular, to aqueous acidic solutions for cleaning aluminum and aluminum alloys.

2. Background Art

Containers comprised of aluminum and alloys thereof are produced in a drawing and forming operation, referred to as drawing and ironing, which results in the deposition of lubricants and forming oils on the surface. In addition, residual aluminum fines, i.e. small particles of aluminum, are deposited on the interior and exterior surfaces of the container during the forming operation. Ordinarily, the exterior surface of the container will have smaller quantities of aluminum fines since during the drawing and ironing step the exterior surface is not subject to as much abrasion from the die as the interior surface.

Prior to any processing steps, such as conversion coating and sanitary lacquer deposition, the surfaces of the aluminum containers must be clean and water-break-free so that there are no contaminants which prevent further processing and which render the containers unacceptable for use.

Acid cleaners have been employed to clean the aluminum surfaces and to remove aluminum fines deposited on the interior walls of aluminum containers. Acid cleaning is ordinarily accomplished at temperatures from 130° F. to 160° F. in order to remove or dissolve the aluminum fines and to remove the lubricants and forming oils so that the surface is rendered water-break-free. The cleanliness of the aluminum surface is measured by the ability of the interior and exterior surfaces of the formed aluminum container to support a continuous break-free film of water, that is to be water-break-free.

Chromic acid or salts thereof have been utilized to minimize the corrosion of processing equipment by inhibiting the corrosive attack of the acid cleaning composition on the processing equipment. An important shortcoming which cleaners of this kind possess is the inherent toxicity of the hexavalent and trivalent chromium compounds contained therein and the resultant waste disposal problem created by the presence of chromium in the cleaner effluent.

Several prior art metal cleaning compositions contain nonylphenols and rosin ethoxylates. Both of these chemicals have recently come under governmental scrutiny and are regulated in several countries. Nonylphenols are suspected of being endocrine disruptors and rosin ethoxylates are thought to have poor biodegradability. Moreover, high performance cleaners that include rosin ethoxylates tend to be somewhat expensive.

Accordingly, there exists a need in the prior art for an improved low cost cleaning composition that is stable, safe, and has improved biodegradability.

### SUMMARY OF THE INVENTION

The present invention overcomes the problems encountered in the prior art by providing in one embodiment, a cleaning composition suitable for cleaning formed metal. The cleaning composition is particularly useful for aluminum and alloy containing aluminum for removing and dissolving aluminum fines and for cleaning lubricating oils from the aluminum. The cleaning composition of the present invention comprises water and:

A) an ethoxylate of an alcohol having Formula R₁—OH wherein R₁ is a saturated or unsaturated, straight-chain or branched aliphatic having from 12 to 22 carbon atoms;

B) an inorganic pH adjusting component; and

C) at least one surfactant that is different than component A.

The composition of the present invention optionally further comprises one or more of the following:

D) a fluoride component; and

E) anti-foaming agents.

In another embodiment of the present invention, a method for cleaning a metal surface with the cleaning composition of the present invention is provided. This method comprises contacting a metal surface with the cleaning composition of the present invention at a sufficient temperature and for a sufficient time to clean the metal surface. Optionally, the treated metal surface is rinsed one or more times with water and/or deionized water. Furthermore, the treated metal surface is then contacted with a conversion coating or other types of surface conditioners.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

Except in the claims and the operating examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; specification of materials in ionic form implies the presence of sufficient counter-ions to produce electrical neutrality for the composition as a whole (any counter-ions thus implicitly specified should preferably be selected from among other constituents explicitly specified in ionic form, to the extent possible; otherwise such counter-ions may be freely selected, except for avoiding counter-ions that act adversely to the objects of the invention); and the term “mole” and its variations may be applied to elemental, ionic, and any other chemical species defined by number and type of atoms present, as well as to compounds with well defined molecules.

The term “aliphatic” as used herein means a straight or branched, saturated or unsaturated hydrocarbon group. Aliphatic includes alkyl groups, alkenyl groups, and alkynyl groups.

The term “alkyl” as used herein means a saturated straight or branched hydrocarbon group.

The term “alkenyl” as used herein means a straight or branched hydrocarbon group that has at least one double bond.

The term “alkynyl” as used herein means a straight or branched hydrocarbon group that has at least one triple bond.

In one embodiment of the present invention, a cleaning composition suitable for cleaning formed metal articles is provided. The cleaning composition of the present invention comprises water and:

A) an ethoxylate of an alcohol having Formula I

R₁—OH I

B) an inorganic pH adjusting component; and

C) at least one surfactant that is different than component A. Preferably, R₁ is a saturated or unsaturated, straight-chain or branched aliphatic having from 14 to 22 carbon atoms. More preferably, R₁ is a saturated or unsaturated, straight-chain or branched aliphatic having from 16 to 20 carbon atoms. The most preferred formula for R₁ include CH₃(CH₂)₇—CH═CH(CH₂)₈— and CH₃(CH₂)1₇—. In a particularly preferred embodiment, R₁ is an alkenyl having 14 to 22 carbon atoms. In this preferred embodiment, R₁ is more preferably an alkenyl having one degree of unsaturation and from 16 to 20 carbon atoms, and most preferably an alkenyl having one degree of unsaturation and 18 carbon atoms. The most preferred formula for R₁ is CH₃(CH₂)₇—CH═CH(CH₂)₈—.

The ethoxylate of an alcohol having formula I is preferably a 5 mole to 30 mole ethoxylate. More preferably, the ethoxylate of an alcohol having formula I is a 10 to 25 mole ethoxylate, and most preferably a 20 mole ethoxylate. Moreover, the ethoxylate of an alcohol having formula I is optionally capped with propylene oxide, chlorine, alkyl, and the like. A particularly preferred ethoxylate is Genapol 0-200 commercially available from Clariant Corporation. Genapol O-200 is a 20 mole ethoxylate of oleyl alcohol. Oleyl alcohol is a primary alcohol with the formula CH₃(CH₂)₇—CH═CH(CH₂)₈OH. Preferably in a working solution, the ethoxylate is present in an amount from about 0.05 gram/liter to about 15 gram/liter of the cleaning composition. The term “working composition” as used herein means a composition used for the actual treatment of metal surfaces. More preferably in a working solution, the ethoxylate is present in an amount from about 0.1 gram/liter to about 10 gram/liter of the cleaning composition, and most preferably in a working solution the ethoxylate is present in an amount of about 0.7 gram/liter of the cleaning composition.

The cleaning composition of the present invention also comprises an inorganic pH adjusting component. The pH adjusting component preferably does not contain fluorine. In one variation of the present invention, an acidic cleaning solution is provided. Accordingly in this variation, the inorganic pH adjusting component is an inorganic acid. Suitable inorganic acids include sulfuric acid, phosphoric acid, nitric acid, or mixtures thereof. The amount of inorganic acid in a working solution will be at least partially determined by the pH ranges set forth below. Preferably in a working solution, the inorganic acid is present in an amount from about 1 gram/liter to about 20 gram/liter of the cleaning composition. More preferably in a working solution, the inorganic acid is present in an amount from about 2 gram/liter to about 10 gram/liter of the cleaning composition; and most preferably in a working solution the inorganic acid is present in an amount of about 5 gram/liter of the cleaning composition. In another variation of the present invention, an alkaline cleaning solution is provided. In this variation, the inorganic pH adjusting component is a base. Suitable bases are alkaline bases which include, but are not limited to, sodium hydroxide and potassium hydroxide. In this variation, a sufficient amount of base is added so that a working solution has a pH from about 9 to 13. More preferably, a sufficient amount of base is added so that a working solution has a pH from about 10.5 to about 12.5; and most preferably a sufficient amount so that the pH of a working solution is from about 11 to about 12.

The cleaning composition of the present invention also comprises a surfactant that is different than component A. This surfactant may or may not also be described by Formula I. Such materials enhance the cleaning performance by assisting in wetting of the metal surface and in the removal of lubricant and oils. The surfactant to be employed herein can be anionic, cationic, or nonionic. Preferably, the surfactant has a low cloud point to control foam. Examples of surface active agents that can be utilized are Genapol TP-1454 (a propoxylated alcohol), Tergitol 08 (sodium 2-ethyl hexyl sulfate), Triton DF-16 (a polyethoxylated straight chain alcohol), Polytergent S-505 LF (a modified polyethoxylated straight chain alcohol), Surfonic LF-17 (an alkyl polyethoxylated ether with a propoxylate cap), Plurafac RA-30 (a modified oxyethylated straight chain alcohol), Triton X-102 (an octylphenoxy polyethoxy ethanol), Plurafac D-25 (modified oxyethylated straight chain alcohol) and Antarox BL 330 (a modified polyethoxylated straight chain alcohol). The surfactant present in the cleaning composition can be a combination of one or more particular surfactants. The preferred surfactant is Surfonic LF-17 commercially available from Huntsman which is a linear polyethoxylated straight chain alcohol having from 12 to 14 carbon atoms. The surfactant is preferably present in an amount from about 0.1 gram/liter to about 15 gram/liter of the cleaning composition. More preferably, the surfactant is present in an amount from about 0.4 gram/liter to about 10 gram/liter of the cleaning composition; and most preferably, the surfactant is present in an amount of about 0.7 gram/liter of the cleaning composition.

The cleaning composition of the present invention is optionally combinable with a composition that has fluoride. Accordingly, the cleaning composition optionally further comprises a fluoride component (component D). Preferably, the fluoride component is derived from the group consisting of hydrofluoric acid and the total and partial salts thereof. Such salts include, for example, sodium fluoride and ammonium bifluoride. Although complex fluoride can be employed, greater concentrations of complex fluoride will be necessary to yield desirable amounts of active fluoride, as the hydrolysis of complex fluorides is not as substantial as with the simple fluoride, to liberate the required active fluoride.

In one variation of the present invention as set forth above, the cleaning solution is highly acidic. Typically such a cleaning solution will have a pH below 2.0. The amount of inorganic acid and if present hydrofluoric acid can be varied within limits in accordance with the ranges set forth hereinabove so that the pH of the cleaning solution can be adjusted. Preferably, the pH of the cleaning solution is adjusted to from about 1.0 to about 1.8, and optimum results, that is excellent cleaning with minimal etching, are obtained when the pH of the cleaning solution is adjusted to from about 1.2 to about 1.5. However, it is understood that for acidic cleaning solutions, the amount of free acid is a preferred parameter for monitoring the acid content of a solution. Free acidity measures the mineral acid content of a process bath as distinct from the acidity contributed by the hydrolysis of metal ions. It is determined by taking a 10 ml sample of a working composition (or the process bath) and adding either sodium or potassium fluoride to complex any metal ions and prevent the hydrolysis of such metal ions. The sample is titrated to a phenolphthalein end point with 0.1 M NaOH. The result is reported as the number of ml needed to reach the endpoint. Free acidity is used in combination with the fluoride component to maintain the desired rate of metal and inorganic soil removal. The free acidity is monitored and replenished using automatic control equipment. Since the mineral acid replenisher contains the surfactants this measurement is also an indirect measure of the surfactant content. Preferably, the free acid content is in the range of 4 ml to 18 ml. More preferably in a working solution, the free acidity is in the range 7 ml to 12 ml, and most preferably about 9 ml.

The working solutions of the present invention are also characterized by the “total acidity” and the “reaction product.” Total acidity measures the acidity due to the mineral acid content of the process bath and that due to hydrolysis of aluminum ions. It is determined by taking a 10 ml sample of the working solution (or process bath) and titrating to a phenolphthalein end point with 0.1M NaOH. The result is reported as the number of ml needed to reach the endpoint. Reaction product is the arithmetic difference between the total acidity and free acidity. The reaction product is roughly proportional to the amount of soluble aluminum in the process bath at the rate of ca. 90 ppm Al per ml of reaction product. It is often regarded as an indirect indicator of a bath's oily soil load. High reaction products are more economical since more chemical remains in the bath. However, if the reaction product is too high it becomes difficult to rinse the cleaner residues from the cans and the build up of oily soils begins to cause waterbreak problems. Preferably, the reaction product is less than 3.5× the free acidity.

Because of the competing complex-forming-and-dissociating equilibria in which fluoride can participate in a working aqueous liquid composition according to this invention that contains hydrofluoric acid and/or polyvalent cations such as aluminum and titanium that can form complex fluorometallate anions, the preferable concentrations for fluoride in such a composition are specified in terms of “active free fluoride”, as measured by means of a fluoride sensitive electrode and associated instrumentation and methods that are known to those skilled in the art. For example, an electrode of this type is described in U.S. Pat. No. 3,431,182 which is hereby incorporated by reference.

“Active free fluoride” as this term is used herein was measured potentiometrically relative to a Standard Solution 120MC commercially available from Henkel Surface Technologies, using a fluoride sensitive electrode commercially available from Orion Instruments. The electrical potential developed between the fluoride sensitive electrode immersed in the Standard Solution at ambient temperature and a standard reference electrode, e.g., a a Ag/AgCl electrode, is measured with a high impedance millivolt meter. The same fluoride sensitive electrode is then well rinsed, carefully dried by wiping with absorbent paper, and immersed in a sample of a composition according to this invention at ambient temperature, and the potential developed between this fluoride sensitive electrode and the same standard reference electrode as before is then measured. The value obtained with the fluoride sensitive electrode immersed in the Standard Solution is subtracted from the value obtained with the fluoride sensitive electrode immersed in the composition according to the invention to yield the values in millivolt(s) (hereinafter often abbreviated “mv” or “mV”) by which the Active Free Fluoride of compositions according to the invention is measured.

Preferred Active Free Fluoride values for working compositions according to the invention correspond to millivolt values that are positive with respect to the standard solution. Therefore, more negative millivolt values correspond to stronger fluoride activities and more positive millivolt values to weaker fluoride activities. In a working composition according to the invention, the mV value preferably from about 5 mV to about 30 mV. More preferably, the mV value is from about 10 to 20 mV; and most preferably about 15 mV. As the cleaning solution is used, aluminum is dissolved off the surface being treated at a specific rate. In general, cleaning solutions of the present invention will have operating characteristics such that initially (i.e., at make-up) the aluminum dissolution rate is from about 8 to about 25 milligrams per square foot (0.009 to 0.027 mg/cm²) of aluminum surface treated. It has been observed that best results, with minimal etch of the surface, are obtained when the aluminum dissolution rate is from 9 to 20 milligrams per square foot (0.01 to 0.022 mg/cm²) of aluminum surface treated. This dissolution rate occurs at make-up of a cleaning solution having from about 0.005 to about 0.1 grams/liter of hydrofluoric acid. By establishing a reference potential point with a potentiometric type electrode at make-up of the cleaning solution, and by recording the potential measurements as metal surfaces are processed and cleaned, the aluminum dissolution rate is maintained within the preferred range by additions of active fluoride, preferably as hydrofluoric acid. So, the potentiometric electrode is used as a guideline for determining when to adjust the amounts of active fluoride in solution, and also to maintain sufficient active fluoride therein to effect a desirable aluminum dissolution rate.

The active fluoride in the cleaning solution aids in the removal of aluminum fines on the metal substrate which have formed during the forming operation. A surprising aspect of this invention is that the cleaning process can be effected when the amount of hydrofluoric acid present in the solution, is as low as 0.005 grams/liter. The preferred amount of hydrofluoric acid results in the presence of sufficient active fluoride to accomplish removal of the aluminum fines without vigorous attack of the underlying aluminum surface. Of course, should the active fluoride be depleted in the cleaning solution, preferably it can be replenished by addition of hydrofluoric acid.

It is normally preferred that compositions according to the invention as defined above should be substantially free from many ingredients used in compositions for similar purposes in the prior art. Such ingredient include hexavalent chromium; ferricyanide; ferrocyanide; ethoxylated rosins; and nonylphenols. Preferably, the compositions of the present invention less than about 1.0% of such ingredients. More preferably, the compositions of the present invention include less than about 0.35% of such ingredients, and most preferably less than about 0.001% of such ingredients.

Another embodiment of the invention is a process of cleaning a metal with a composition as described above. In this embodiment of the invention, the metal to be cleaned is contacted with the compositions of the present invention. The metal surface should be cleaned employing techniques that result in a completely water-break-free surface. The cleaning solution can be applied to the aluminum surface utilizing any of the contacting techniques known to the art. Preferably, application will be effected by conventional spray or immersion methods. Preferably, the temperature at which the metal is contacted is from about 60° F. to about 160° F. More preferably, the contacting temperature is from about 90° F. to about 150° F., and most preferably from about 120° F. to 150° F. This is a distinct advantage of the present invention over some prior art processes, as the low operating temperatures with good cleaning results prevents accelerated corrosion and attack of processing equipment. The time of contact between a working composition according to the invention and a metal substrate to be treated preferably is from about 1 to about 1800 seconds. More preferably, the time of contact is from about 3 seconds to about 180 seconds, and most preferably from about 30 to 120 seconds. Independently, it is preferred that the metal surface thus treated be subsequently rinsed with water in one or more stages before being dried. Usually, one or more aqueous rinses are applied to the cans following the cleaning step and prior to oven drying, decoration, and application of sanitary lacquers. In one embodiment of the present invention the rinsing process would consist of one to three tap water rinses and a final rinse with deionized water. For reasons of economy and efficiency, these may include the use of recirculated rinses in addition to virgin rinses, with or without adjustment of the rinses pH or conductivity. These, and numerous other rinse schemes are well known to those skilled in the art.

In another embodiment, cans that have been cleaned with the present invention may be rinsed and then subjected to any of several subsequent surface modifying treatments, separately or in combination, with the intention of imparting certain desirable characteristics to the cans surface. For example, cans cleaned with the present invention may be rinsed with recirculating and/or virgin water followed by treatment with a “conversion coating” to improve their stain resistance or to improve the adhesion of subsequently applied decorative coatings or sanitary lacquers, or to reduce the static coefficient of friction of the cans. Examples of these surface-modifying treatments are described in U.S. Pat. Nos. 4,184,670; 4,370,177; 5,030,323; and 5,476,601. The entire disclosure of each of these patents is hereby incorporated by reference. Typically, the conversion coating is applied to the cans in Stage 4 of six or seven stage power spray washers and is followed by additional recirculating and virgin tap water and deionized water rinses prior to oven drying.

In still another embodiment of the invention described herein, the cans may be cleaned with the present invention and rinsed as previously described with a surface modifying agent dissolved in the final deionized water rinse or in a separate application stage following the virgin deionized water rinse. Some representative “final-rinse” treatments of this kind are described in U.S. Pat. Nos. 5,080,814 and 6,040,280. The entire disclosure of each of these patents is hereby incorporated by reference.

In yet another embodiment of the invention described herein, it is possible to combine the use of the present invention with the “conversion coating” surface treatments and with the “final-rinse” surface treatments described above.

In another embodiment of the present invention, a concentrated cleaning composition is provided. This concentrated cleaning composition is combined together with water to form the working solution as set forth above. The concentrated cleaning composition includes each of the components disclosed above for a working composition. These components are water and:

A) an ethoxylate of an alcohol having Formula R₁—OH wherein R₁ is a saturated or unsaturated, straight-chain or branched aliphatic having from 12 to 22 carbon atoms;

B) an inorganic pH adjusting compound that does not contain fluorine;

C) at least one surfactant that is different than component A.; and optionally,

D) a fluoride component; and

E) anti-foaming agents.

However, components A, B, C are in concentrations that are higher than for a working composition. Preferably, these components are in amounts that are from about 5 to 100 times higher than for a working composition.

The practice of this invention may be further appreciated by consideration of the following, non-limiting, working examples.

### Test Methods

1. Foaming

Foaming characteristics of the cleaning composition were determined as follows. A concentrate is diluted to a sufficient extent to form a 0.06% working solution. Aluminum sulfate and ammonium bifluoride are added to build artificial reaction product corresponding to the same dilution and the solution's pH is adjusted to pH 5 with aqueous ammonia. One liter of the solution is placed in a 4 liter graduated cylinder and then sparged at 86° F. with nitrogen at ½ liter per minute while monitoring the total fluid volume (foam+liquid) at one minute intervals for a period of 10 min. or until the foam reaches the top of the graduated cylinder. The foam build rate is characterized by the initial foam volume which is defined as the foam volume at 4 minutes. The foam is further characterized by the persistent foam volume which is the foam volume at 10 minutes after the nitrogen sparge is turned off.

2. Water-Break

Water-break is a measure of the ability of a clean surface to support a continuous break-free sheet water. Water-Break percentages were measured by visual estimation by an experienced rater as the percent of the total surface area which supports a continuous film of water.

### Example 1

Concentrated cleaning solutions were prepared according to the compositions provided in Table 1. Each component is given in a weight percentage of the total concentrate composition. Concentrates A and B correspond to the cleaning solutions of the present invention. Concentrate K corresponds to a commercially available high performance cleaner. Concentrate K is characterized as having a cloud point of 39° C. and concentrate A as having a cloud point of 59.5° C. Working solutions for each concentrate were prepared by adding 12.82 grams of concentrate to a liter of water (referred to as compositions A through K.) The working solutions further included enough hydrofluoric acid to give a fluoride reading of about 15 mV by the method described above. The working solutions were further characterized by a free acid content of about 9 ml, a total acidity of about 22, and a reaction product of about 13.

TABLE 1
Weight percentages for cleaning concentrates

| Component | A | B | C | D | E | F | G | H | I | J | K |
|---|---|---|---|---|---|---|---|---|---|---|---|
| water | 55.0 | 55.0 | 45.0 | 43.52 | 58.5 | 50.5 | 50.5 | 50.5 | 50.5 | 54.8 | 52.0 |
| 93% H2SO4 | 37.0 | 37.0 | 45.0 | 45.58 | 34.5 | 37.0 | 37.0 | 37.0 | 37.0 | 37.2 | 37.0 |
| Triton DF-16 | | | 9.3 | 10.12 | | | | | | | |
| Plurafac D-25 | | | 0.7 | 0.78 | 3.0 | | 6.25 | | | | |
| Genapol TP- | | 4.0 | | | | | | | | | |
| 1454 | | | | | | | | | | | |
| Chemax AR- | | | | | | 6.25 | 6.25 | 6.25 | 6.25 | | 5.5 |
| 497 | | | | | | | | | | | |
| Triton CF-10 | | | | | | 6.25 | | | | | |
| Antarox LF-330 | | | | | | | | 6.25 | | | |
| Trycol 6720 | | | | | | | | | 6.25 | | |
| Tergitol NP-9 | | | | | | | | | | 4.665 | |
| Surfonic LF-17 | 4.0 | | | | | | | | | 3.335 | 5.5 |
| Plurafac RA-30 | | | | | 4.0 | | | | | | |
| Genapol O-200 | 4.0 | 4.0 | | | | | | | | | |

The effectiveness of the cleaning solutions was evaluated by subjecting aluminum test cans to an aqueous sulfuric acid prewash for about 30 seconds at about 140° F., wherein the prewash had a pH of about 2.0. The test cans were then contacted with the working solutions for about 60 seconds at a temperature of about 145° F. The test cans were then contacted with a more dilute concentration of the working solutions (50 ml cleaner bath per liter of working solution) at ambient temperatures for 30 seconds. This more dilute working solution mimics the resulting drag-through in commercial can washers. The cans were next rinsed with tap water for about 30 seconds and then deionized water for about 90 seconds. The cans were evaluated as follows.

The aluminum surfaces were tested for water-break following cleaning. Table 2 provides the average water-break percentages on the exterior surface for four test cans. Water-break percentage is the percentage of water-break free surface. Table 3 provides the average water-break percentages on the interior surface for 4 test cans. The values for a working composition prepared from concentrates A-K are provided for freshly prepared concentrates. The working solutions corresponding to concentrates A and B are observed to have break water performance superior to that of composition C-K.

TABLE 2
Average Water-Break percentages for the
exterior wall surfaces as prepared.

| composition | as prepared |
|---|---|
| A | 100 |
| B | 100 |
| C | 20 |
| D | 4 |
| E | 54 |
| F | 51 |
| G | 94 |
| H | 56 |
| I | 43 |
| J | 35 |
| K | 73 |

TABLE 3
Average Water-Break percentages for the
interior wall surfaces as prepared.

| composition | as prepared |
|---|---|
| A | 100 |
| B | 100 |
| C | 100 |
| D | 100 |
| E | 100 |
| F | 100 |
| G | 100 |
| H | 100 |
| I | 100 |
| J | 100 |
| K | 100 |

Tables 4 and 5 provide foaming characteristics of working solutions formed from compositions A-K. Although composition A of the present invention foams more than the composition of concentrate I the foam is observed to rapidly dissipate as evident from Table 5. Table 5 gives the foam volume 10 minutes after a gas sparge is stopped. Moreover, the foam characteristics of the composition of the present invention are not unacceptably high.

TABLE 4
Volume of foam in ml produced by
a 4 minute gas sparge. prepared.

| composition | as prepared |
|---|---|
| A | 2050 |
| B | 200 |
| C | 850 |
| D | 1350 |
| E | 2200 |
| F | 600 |
| G | 2350 |
| H | 600 |
| I | 250 |
| J | 2350 |
| K | 500 |

TABLE 5
Volume of foam in ml remaining after
a 4 minute gas sparge.

| composition | as prepared |
|---|---|
| A | 0 |
| B | 0 |
| C | 0 |
| D | 0 |
| E | 0 |
| F | 0 |
| G | 200 |
| H | 0 |
| I | 0 |
| J | 0 |
| K | 1050 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A cleaning composition for formed metal articles, the cleaning composition comprising water and:
A) an ethoxylate of an alcohol having Formula I
R₁—OH I
wherein R₁ is a saturated or unsaturated, straight-chain or branched alkyl having from 12 to 22 carbon atoms;
B) an inorganic pH adjusting component; and
C) at least one surfactant that is different than component A.

2. The cleaning composition of claim 1 wherein the inorganic pH adjusting component is an inorganic acid.

3. The cleaning composition of claim 2 wherein the inorganic acid is sulfuric acid, phosphoric acid, nitric acid, or mixtures thereof.

4. The cleaning composition of claim 2 wherein the free acidity is from about 4 ml to about 18 ml.

5. The cleaning composition of claim 1 wherein the inorganic pH adjusting component is base.

6. The cleaning composition of claim 5 wherein the base is sodium hydroxide or potassium hydroxide.

7. The cleaning composition of claim 5 wherein pH is from about 9 to about 13.

8. The cleaning composition of claim 1 wherein R₁ is a saturated or unsaturated, straight-chain or branched alkyl having from 14 to 22 carbon atoms.

9. The cleaning composition of claim 1 wherein R₁ is a saturated or unsaturated, straight-chain or branched alkyl having from 16 to 20 carbon atoms.

10. The cleaning composition of claim 1 wherein R₁ is a saturated alkyl having from 16 to 20 carbon atoms.

11. The cleaning composition of claim 1 wherein R₁ is CH₃(CH₂)₇—CH═CH(CH₂)₈OH or CH₃(CH₂)₁₇OH.

12. The cleaning composition of claim 1 wherein component A is formed by reacting from about 5 to 30 moles of ethylene oxide with the alcohol having the Formula R₁ —OH.

13. The cleaning composition of claim 1 wherein component A is capped with propylene oxide, chlorine, or alkyl.

14. The cleaning composition of claim 1 wherein
the ethoxylate of an alcohol having Formula R₁ —OH is present in an amount from about 0.05 gram/liter to about 15 gram/liter of the cleaning composition;
the at least one surfactant that is different than component A is present in an amount from about 0.1 gram/liter to about 15 gram/liter of the cleaning composition; and
the inorganic acid is present in an amount from about 1 gram/liter to about 20 gram/liter of the cleaning composition.

15. The cleaning composition of claim 1 wherein
the ethoxylate of an alcohol having Formula R₁ —OH is present in an amount from about 0.4 gram/liter to about 10 gram/liter of the cleaning composition;
the at least one surfactant that is different than component A is present in an amount from about 0.4 gram/liter to about 10 gram/liter of the cleaning composition; and
the inorganic acid is present in an amount from about 2 gram/liter to about 10 gram/liter of the cleaning composition.

16. The cleaning composition of claim 1 wherein
the ethoxylate of an alcohol having Formula R₁ —OH is present in an amount of about 0.7 gram/liter of the cleaning composition; and
the at least one surfactant that is different than component A is present in an amount of about 0.7 gram/liter of the cleaning composition; and
the inorganic acid is present in an amount of about 5 gram/liter of the cleaning composition.

17. The cleaning composition of claim 1 further comprising a fluoride ion source.

18. A method of cleaning a metal surface, the method comprising:
a) contacting a metal surface with the cleaning composition of claim 1 at a sufficient temperature and for a sufficient time to clean the metal surface.

19. The method of claim 18 wherein the metal surface is contacted with the cleaning solution for about 1 second to about 1800 seconds.

20. The method of claim 18 wherein the metal surface is contacted with the cleaning solution at a temperature from about 60° F. to about 180° F.

21. The method of claim 18 further comprising:
b) rinsing the metal surface with water; and
c) drying the metal surface.

22. The method of claim 18 further comprising contacting the metal surface with a conversion coating.

23. The method of claim 18 further comprising contacting the metal surface with a surface modifying agent.
